(19) United States
(12) Patent Application Publication
(10) Pub. No.: US 2013/0238699 A1
(43) Pub. Date: Sep. 12, 2013

(54) SOCIAL NOTIFICATION SYSTEM

(71) Applicant: Ryan Preston Reed, Woodinville, WA (US)

(72) Inventor: Ryan Preston Reed, Woodinville, WA (US)

(21) Appl. No.: 13/413,569

(22) Filed: Mar. 6, 2012

(51) Int. Cl. G06F 15/16

(52) U.S. Cl. 709/204

(57) ABSTRACT

The invention, Social Notification System (SNS), is a method and system for notifying users that changes have occurred to various content or events, including, changes to Web content, new product launches, updated user profiles, non-Web events (beginning of a social gathering), or other changes or events have occurred. Web surfers will select content or events from a publisher's site by clicking on a button, hypertext link, widget icon, or by selecting by other means provided by the publisher, whereby the end user will receive notifications regarding such chosen content or events. The buttons or widgets may be provided by a SNS script or may be provided by the publisher of the content or event. The content chosen will be tracked by the SNS, so that the end user can be notified, by the SNS, of changes or events. These notifications will be sent out in various intervals and methods.

### CROSS-REFERENCE TO RELATED APPLICATIONS

This application claims the benefit of U.S. Provisional Application No. 60/614,52602, filed 14 Mar. 2011 21:44:28.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Currently, there is no central and proactive method for content publishers to notify non registered users of specific changes, or events to their content, applications, or offline events. In addition, there is no current method for the verification of content changes that result in notifications being sent to non-registered users without proactive interaction from the publisher of the content. Many web surfers browse news sites, blogs, social networks or other interactive sites on the web. These users may not sign up for an account at each Website they visit, but still would want to receive notifications that changes to the content, user profiles or applications have occurred, so that they could return to the location of the content and view the changes. Web surfers may use a third party bookmarking service or bookmark such page in their Web browser in order to revisit the page in the future.

### SUMMARY OF THE INVENTION

The invention, Social Notification System (SNS), is a method and system for notifying users that changes have occurred to various content or events, including, changes to Web content, new product launches, updated user profiles, non-Web events (beginning of a social gathering), or other changes or events have occurred. Web surfers may select content or events from a publisher's site by clicking on a button, hypertext link, widget icon, or by selecting by other means provided by the publisher, whereby the end user may receive notifications regarding such chosen content or events. The buttons or widgets may be provided by a SNS script or may be provided by the publisher of the content or event. The content chosen may be tracked by the SNS, so that the end user can be notified, by the SNS, of changes or events. These notifications may be sent out in various intervals and methods.

### BRIEF DESCRIPTION OF THE DRAWINGS

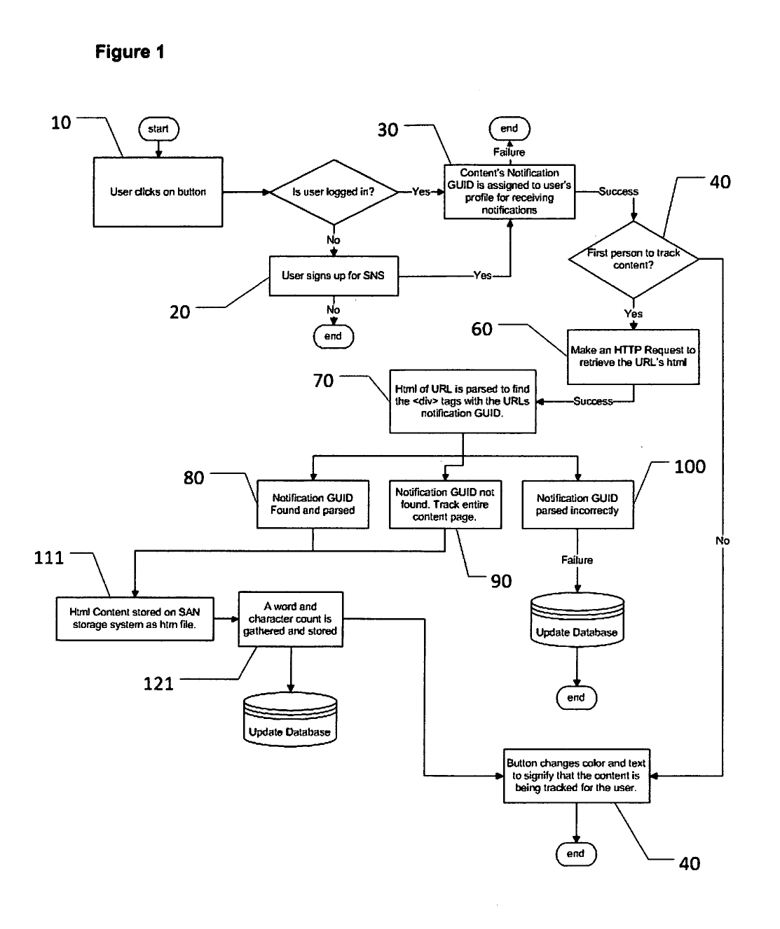

In FIG. 1, a process flow for a user to sign up to be notified by the Social Notification System (SNS) from a specified publisher's site.

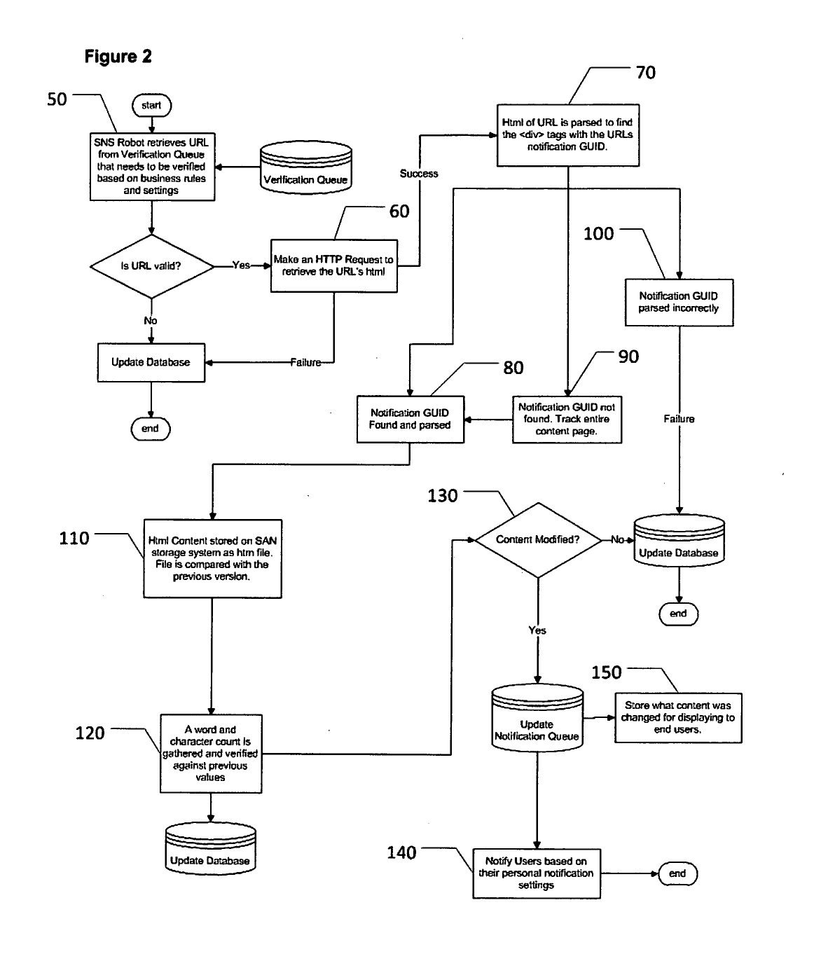

In FIG. 2, a process flow for the Social Notification System (SNS) to verify that specific content has been updated without the publisher needing to send updates to the Social Notification System; whereby, the end users are notified.

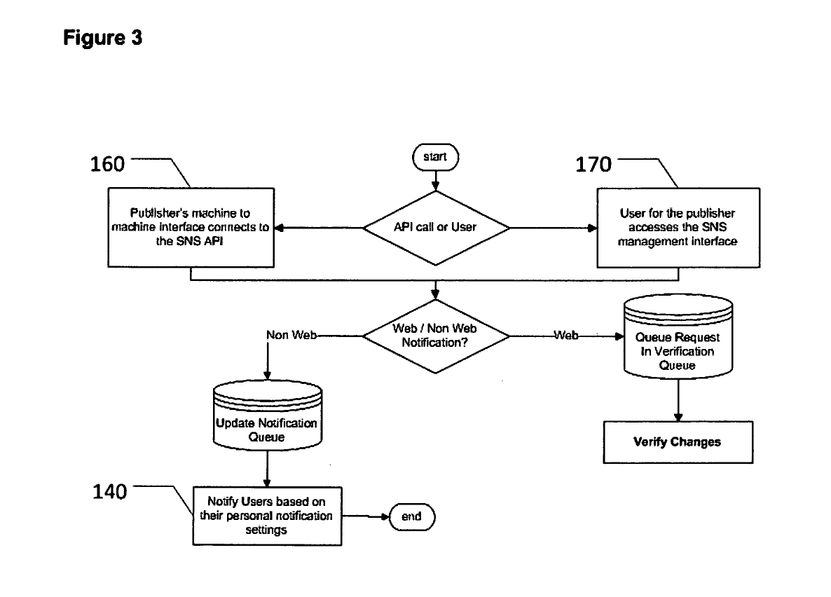

In FIG. 3, a process flow for publishers to notify the Social Notification System (SNS) that specific content has been updated; whereby, the end users are notified.

### DETAILED DESCRIPTION

The features of the invention, Social Notification System (SNS), provide the ability for publishers to notify registered and non-registered end users when changes or events occur. The changes can be, but are not limited to, user profile modifications, update to media content, new comments, changes to informational content, the beginning of Web events (live streaming media), or when other application changes occur. In addition, when non-Web events occur, the SNS can be notified by the publisher, in real-time or a schedule, whereby the end users may be notified of that event. The SNS allows the end users to be notified without the need for the end user to register for an account and provide personal information to the publisher of the content. The end user only needs to register for an account with the SNS to receive notifications from publishers. The SNS provides functionality that checks for publisher content changes without the need for the publisher to notify the SNS that changes have occurred; thereby, providing the publishers the ability to notify end users of changes to Web content without directly notifying the SNS or end user of the changes. The publisher can simply set settings in the SNS management area whereby the SNS may automatically check for changes to the Web content.

In order for the publishers to set the region within their Web site for what content may be tracked by the SNS, the publishers can place html tags with unique IDs wrapped around the content (Notification Sections). Such Notification Sections may be wrapped with DIV tags with unique GUIDs (Notification GUID), which may allow multiple sections of a Web page to be tracked independently. These Notification Sections also serve to isolate the content from other dynamic content served on the page that should not cause a notification to be sent to an end user. The SNS may parse the publisher's html pages looking for the Notification Sections by using the Notification GUID. If no Notification Section is detected or if an empty Notification Section is detected, the entire page can be tracked for changes by the SNS, which can be controlled by settings set by the publisher. The Notification Sections also provide the ability for the SNS to highlight the section that is being tracked on the publisher's site for the end user. Notification GUIDs are also used to uniquely identify specific types of media changes or non-Web events, where they are sent to the SNS API by the publisher.

The SNS also provides features, which allow Users to choose the type of notifications that they receive for specific type of content or publisher. These notification settings, can allow the user to receive notifications only via their web management interface, instant, weekly, monthly or other time based interval email notifications, or a time based interval SMS notification or other third party notification process such as posting to a social network's API interface.

The SNS must be able to distribute Widgets in the form of a scripting language, such as JavaScript, or HTML frames in order to allow end users to sign up with the SNS to receive notifications from publishers (FIG. 1). Whereby the user clicks on a button 10 and logs into the system if not already logged in 20 and a globally unique identifier (GUID) is assigned to the user's profile 30. If the content has not been associated with an existing user's account 40 then a request is made 60 to retrieve the content to be tracked. The HTML content is parsed by various different means to extract the specified content 70 to be tracked. If upon parsing the HTML, a notification GUID is found 80 that GUID may be associated with the tracked content and stored on a storage device 111, which may be in the cloud or other storage solution. If the notification GUID is not found in the HMTL page, the entire page may be tracked or portions of the page may be tracked based on user determination 90. If a GUID is found but passed incorrectly 100, the process may end with an error. Upon finding and storing the content in the storage system 111, a method to determine the content being stored, including word counts, character counts, hash values 121, may be stored with the content. A button may be included, which may change color or graphics to signify that the content is being tracked already by the user 40. The end users should not be required to provide registration information to the publishers of the content in order to receive notifications from them. An end user should only need to register one time with the SNS.

The SNS must have systems and applications in place to verify that changes have occurred on publisher's sites without requiring the publisher to notify the SNS that changes have occurred (FIG. 2). The SNS may contain a queue where standalone applications may retrieve requests for verifying content changes 50. A request may be made 60 to retrieve the HTML of the location where the content was originally located. The HTML is parsed 70 to find the original content 80, 90, 100 being tracked, which may include a GUID to identify the content or other parsing method. Once the content is determined, it may be compared to the information stored in the database or filing system to determine if changes have been made 110, 120 to the content. If the content is modified 130, the content may be updated in the database to show to users 150 and the user may be notified 140 through various methods, including email, mobile application push notifications, or SMS notifications. In addition, the SNS must be able to handle various degrees of changes that occur to content, which may be done by tracking very specific details of what has changed and the degree of change. For example, the SNS must be able to track the number of words, number of characters, size of page in Kilobytes, size of media content, or other in order to determine intelligently whether a change event has occurred, which is handled by business logic contained within the SNS. Users may have the ability to set this degree of change so that specific sensitivity of changed is tailored to the end user.

The SNS must provide the necessary programming interfaces 160 for publishers to proactively notify the SNS of changes or events (FIG. 3). A publisher may have their servers communicate with the SNS via programming interfaces 160 to notify the SNS that changes have been made or a user interface 170 may be provided to the publisher of the content where they may be able to notify the SNS of changes to the content, which may notify end users 140 of such changes and update the database where the content is stored to be displayed to the end user. The SNS must also provide the necessary user interfaces 170 for a publisher with no technical expertise to notify the SNS that a change or events have occurred (FIG. 3).

In broad embodiment, the present disclosure is a system that allows media sources to be tracked by users where they may be notified if such media sources change in any way.

While the foregoing written description of the present disclosure enables one of ordinary skill to make and use what is considered presently to be the best mode thereof, those of ordinary skill may understand and appreciate the existence of variations, combinations, and equivalents of the specific embodiment, method, and examples herein. The present disclosure should therefore not be limited by the above described embodiment, method, and examples, but by all embodiments and methods within the scope and spirit of the present disclosure.

The embodiments of the invention in which an exclusive property or privilege is claimed are defined as follows:

I claim:

1. A notification system that provides functionality to check for publisher content changes; thereby, providing the end users notifications of publisher modifications.
